(19) United States
(12) Patent Application Publication
(10) Pub. No.: US 2019/0161667 A1
(43) Pub. Date: May 30, 2019

(54) HIGH DENSITY BRINES

(71) Applicants: Marshall Chiasson, Spring, TX (US); James Allensworth, Houston, TX (US); Moctesuma R. Trevino, Houston, TX (US)

(72) Inventors: Marshall Chiasson, Spring, TX (US); James Allensworth, Houston, TX (US); Moctesuma R. Trevino, Houston, TX (US)

(73) Assignee: Baker Hughes, a GE company, LLC, Houston, TX (US)

(21) Appl. No.: 15/823,742

(22) Filed: Nov. 28, 2017

(51) Int. Cl. C09K 8/06; C09K 8/86; C09K 8/84; E21B 36/00

(52) U.S. Cl. CPC C09K 8/06; E21B 36/003; C09K 8/845; C09K 8/86

(57) ABSTRACT

A method of treating a wellbore comprises injecting into the wellbore a high density brine comprising water; an inorganic salt; and a polyol having at least four hydroxyl groups per molecule, the polyol being present in an amount effective to cause the high density brine to have a density of about 14.2 pounds per gallon to about 22 pounds per gallon; and to suppress the true crystallization point of the brine to about −70° F. to about 70° F. at a pressure of about 0 to about 20000 psi determined according to API 13J.

### BACKGROUND

In the oil and gas industry, it is often desirable to treat formation with completion brines to facilitate final operations prior to the start of production. Such final operations include setting screens and production liners, packers, downhole valves and/or shooting perforations into the producing zone(s). One important property of the brines is density. For certain applications, particularly those wells having a high true vertical depth and high bottomhole pressure, it is essential to use brines that have high density in order to control the wellbore. However, the maximum density that can be achieved is often limited by the maximum solubility of the salts. In addition, at high salt loadings, salts may precipitate when temperature drops. Further, salts can also crystallize above the established crystallization temperature when additional pressures are applied during blow out preventer testing. This effect increases the temperature that crystallization will occur when pressure is applied above the pressure observed in other operations. The formation of solids can plug the workstring, causing expensive downtime and requiring that the plug be cleared.

Thus, alternative high density brines that effectively suppress crystallization under different temperatures and pressures are desired in the art. It would be a further advantage if such high density brines have balanced rheology and filterability.

### BRIEF DESCRIPTION

A method of treating a wellbore comprises injecting into the wellbore a high density brine comprising water; an inorganic salt; and a polyol having at least four hydroxyl groups per molecule, the polyol being present in an amount effective to cause the high density brine to have a density of about 12.5 pounds per gallon to about 22 pounds per gallon; and to suppress the true crystallization point of the brine to about −70° F. to about 70° F. at a pressure of about 0 psi to about 20,000 psi, determined according to API 13J.

A method of making a high density brine having a balanced density, true crystallization temperature, and rheology comprises preparing two or more brine samples having a target brine density from water, an inorganic salt, and a polyol having at least four hydroxyl groups per molecule, the two or more brine samples having increasing amounts of the polyol; measuring a rheological property and a true crystallization temperature at a predetermined pressure for each of the brine samples; establishing a correlation between the amount of the polyol with the measured rheological property and true crystallization temperature; selecting an amount of the polyol based on a target value of the rheological property and target true crystallization temperature; and preparing the high density brine having a balanced density, true crystallization temperature, and rheological property with water, the inorganic salt, and the selected amount of the polyol.

### BRIEF DESCRIPTION OF THE DRAWINGS

The following descriptions should not be considered limiting in any way. With reference to the accompanying drawings, like elements are numbered alike:

FIG. 1 shows the true crystallization temperature (TCT) of various brines containing calcium bromide and glucose as a function of the brine density;

FIG. 2 shows the TCT of various brines containing calcium chloride and glucose as a function of the brine density;

FIG. 3 shows the TCT of brines containing calcium bromide and various polyols as a function of brine density;

FIG. 4 shows the effect of sorbitol addition to calcium bromide brines on viscosity and TCT;

FIG. 5 shows the effect of sorbitol addition to calcium bromide brines on PCT (pressurized true crystallization temperature);

FIG. 6 shows the effect of sorbitol addition to calcium bromide brines on filtration time and TCT; and

FIG. 7 shows the effect of sorbitol addition to sodium brines on viscosity and TCT.

### DETAILED DESCRIPTION

The inventors hereof have discovered that brine true crystallization temperature values as well as pressurized brine true crystallization values can be effectively suppressed using the polyols as disclosed herein. In particular, the addition of polyols allows for higher brine densities to be achieved at target true crystallization temperatures. In addition, for any given brine density, the addition of polyols lowers the brine true crystallization temperature values. Further, the inventors have found that the new brine systems can remain Newtonian in rheology with a direct correlation between viscosity increase and TCT suppression. A method thus has been developed to optimize the TCT suppression by varying the concentration of the polyol. The discovery allows the manufacture of brines having balanced density, true crystallization temperature, and rheology properties. With the disclosed methods and new brine systems, an operator can move away from zinc bromide, expand the density range that can be achieved by current brines while at the same time maintaining or further improving the rheology properties of the brines.

As used herein, “true crystallization temperature” refers to the maximum temperature reached after crystallization begins. TCT is evaluated according to API 13J procedures. A polyol having at least four hydroxyl groups per molecule has been found to be particularly effective in providing high density brines that have low TCT and excellent rheological properties.

As used herein, the polyols include sugar alcohols. Exemplary polyols include glucose, dextrose, fructose, maltose, and sorbitol. The polyols can be used in a pure form such as powders or liquids. Alternatively the polyols can be added as a solution, for example an aqueous solution. Various syrups can be used. Exemplary syrups include corn syrup, sorbitol syrup, trehalose syrup, and fructose syrup. Combinations of the polyols can be used.

The polyols can be combined with an inorganic salt and water to form the high density brines. Exemplary inorganic salts include calcium bromide, calcium chloride, potassium chloride, potassium bromide, sodium chloride, sodium bromide, sodium formate, potassium formate, cesium formate, zinc bromide, zinc chloride, ammonium chloride, or a combination comprising at least one of the foregoing. Calcium bromide, calcium chloride, and sodium bromide are specifically mentioned. The high density brines can include two or more inorganic salts, for example a combination of divalent and monovalent salts. In an embodiment, the high density brines are free of zinc bromide. In another embodiment, the high density brines are free of solids. The inorganic salts can be present in an amount of about 2 wt. % to about 75 wt. %, about 13 wt. % to about 75 wt. % or about 2 wt. % to about 55 wt. % based on the total weight of the high density brines.

The polyols are present in an amount effective to cause the high density brines to have a density of about 12.5 pounds per gallon (ppg) to about 22 pounds per gallon; and to suppress the true crystallization point of the high density brine to about −70° F. to about 70° F. at the atmospheric pressure determined according to API 13J procedures. Preferably, the density of the brines that can be achieved using the polyols as disclosed herein can be about 15 ppg to about 20 ppg, or about 15.5 ppg to about 18 ppg. The true crystallization point of the high density brines is preferably about 0° F. to about 60° F. or about −30° F. to about 60° F. at the atmospheric pressure determined according to API 13J procedures. The pressurized true crystallization point of the high density brines is preferably about 0 to about 30° F. or about 10° F. to about 40° F. at a pressure of about 0 psi to about 20,000 psi, determined according to API 13J procedures.

In an embodiment, the amount of the polyols in the high density brines is about 10 w. % to about 50 wt. % or about 15 wt. % to about 45 wt. %, or about 20 wt. % to about 40 wt. %, based on the total weight of the high density brine.

The amount of the polyol can be optimized to provide brines having balanced density, true crystallization temperature, and rheological properties. The inventors have found that rheology and filtration time are roughly proportional to the degree of TCT suppression and polyol concentration for a given density. Given a density and TCT, a formulation can then be optimized to achieve required rheology and filtration time.

A method of optimizing the amount of the polyol includes preparing two or more brine samples having a target brine density from water, an inorganic salt, and a polyol having at least four hydroxyl groups per molecule, the two or more brine samples having increasing amounts of the polyol; measuring the rheological properties such as viscosity and filterability and the true crystallization temperature at a predetermined pressure for each of the brine samples; establishing correlations between the amount of the polyol and the rheological properties and true crystallization temperature; and selecting an amount of the polyol based on a target rheological property and target true crystallization temperature.

In an embodiment, the high density brines remain Newtonian in rheology under downhole conditions. The high density brines as disclosed herein have a viscosity of about 6 cp to about 300 cp or about 18 cp to about 171 cP at 21° C. determined according to API 13J. The high density brines as disclosed herein can also have desired filterability by tuning the amount of the polyol present in the high density brines. Filterability can be determined by the time for 350 mL of brine to flow through a glass fiber and diatomaceous earth (DE) filter media under vacuum. FIG. 6 quantifies filterability of 14.7 ppg CaBr₂ and sorbitol blends by comparing filtration time to TCT at various concentrations of sorbitol. An optimal amount of sorbitol can be selected based on the target filterability and target true crystallization temperature.

Specific exemplary high density brines include a single salt brine comprising calcium bromide in an amount of about 50 to about 55 wt. % and the polyol as described herein such as sorbitol present in an amount of about 20 wt. % to about 40 wt. % each based on a total weight of the single salt brine, and such single salt brine has a density of about 14.4 ppg to about 15.7 ppg and a TCT of about −70° F. to about 76° F. determined according to API 13J. Another exemplary high density brine is a single salt brine comprising calcium chloride in an amount of about 33 wt. % to about 40 wt. % and the polyol as described herein such as sorbitol present in an amount of about 20 wt. % to about 40 wt. %, each based on a total weight of the single salt brine, and such single salt brine has a density of about 11.0 ppg to about 12.4 ppg and a TCT of about −40° F. to about 70° F. determined according to API 13J.

The high density brines are completion brines, perforating brines, packer brines, drill-in brines, or an oil-based mud internal phase. The oil-based mud can be a drilling mud which includes an oil and a high density brine as disclosed herein. The oil in the oil-based mud is the continuous or external phase, and may comprise any oil including, but not limited to, a diesel oil; a paraffin oil; a vegetable oil; a soybean oil; a mineral oil; a crude oil; a gas oil; kerosene, an aliphatic solvent, an aromatic solvent; a synthetic oil; or a combination comprising at least one of the foregoing.

The high density brines can be used in various wellbore operations such as a completion operation, a drilling operation, a workover operation, an abandonment operation, or a combination comprising at least one of the foregoing. The high density brines can be injected into the wellbore or circulated in the wellbore during a wellbore operation.

### EXAMPLES

### Example 1

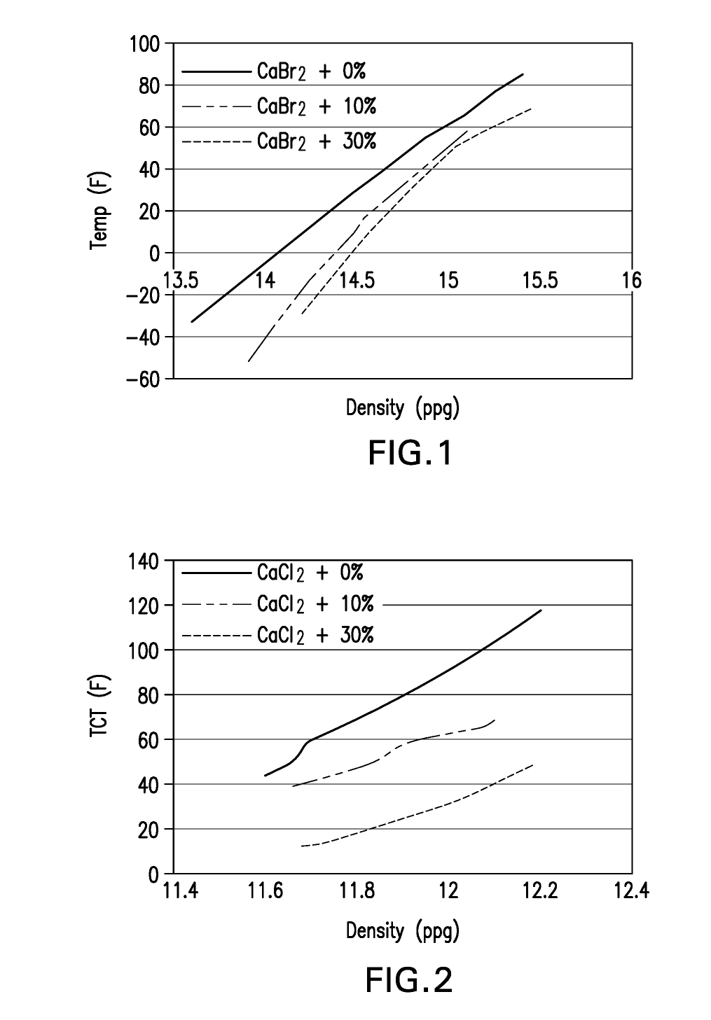

Three series of samples were prepared. The first series include calcium bromide bines having different densities. The second series include brines containing calcium bromide and 10 wt. % of glucose having different brine densities. The third series include brines containing calcium bromide and 30 wt. % of glucose having different brine densities. The TCTs of the brines at atmospheric pressure were measured and the results are shown in FIG. 1.

The results indicate that calcium bromide brine TCT values can be suppressed by adding glucose. For example, for a brine with a density of 14.5 ppg, without any glucose, the calcium bromide brine has a TCT value of about 28° F., but when 10 wt. % or 30 wt. % of glucose is added, the TCT value is lowered to 18° F. or 0° C. respectively. The results also indicate that using glucose can expand the maximum brine density that calcium bromide can achieve at a given TCT value. For example, without any glucose, a calcium bromide brine with a density of 14 ppg has a TCT value of about 0° C. The use of 30 wt. % of glucose allows the same TCT value to be achieved at 14.5 ppg.

### Example 2

Three series of samples were prepared. The first series include calcium chloride bines having different densities. The second series include brines containing calcium chloride and 10 wt. % of glucose having different brine densities. The third series include brines containing calcium chloride and 30 wt. % of glucose having different brine densities. The TCTs of the brines at atmospheric pressure were measured and the results are shown in FIG. 2.

The results indicate that calcium chloride brine TCT values can be suppressed by adding glucose. For example, without any glucose, a calcium chloride brine has a TCT of 44° F. at 11.6 ppg but making the same density fluid containing 10% glucose decreases the TCT to 34° F. and increasing the glucose more to 30% decreases the TCT to 9° F. The results also show that the use of 30 wt. % glucose for CaCl₂) allows the same TCT value (44° F.) to be achieved at 12.1 ppg rather than the current 11.6 ppg.

### Example 3

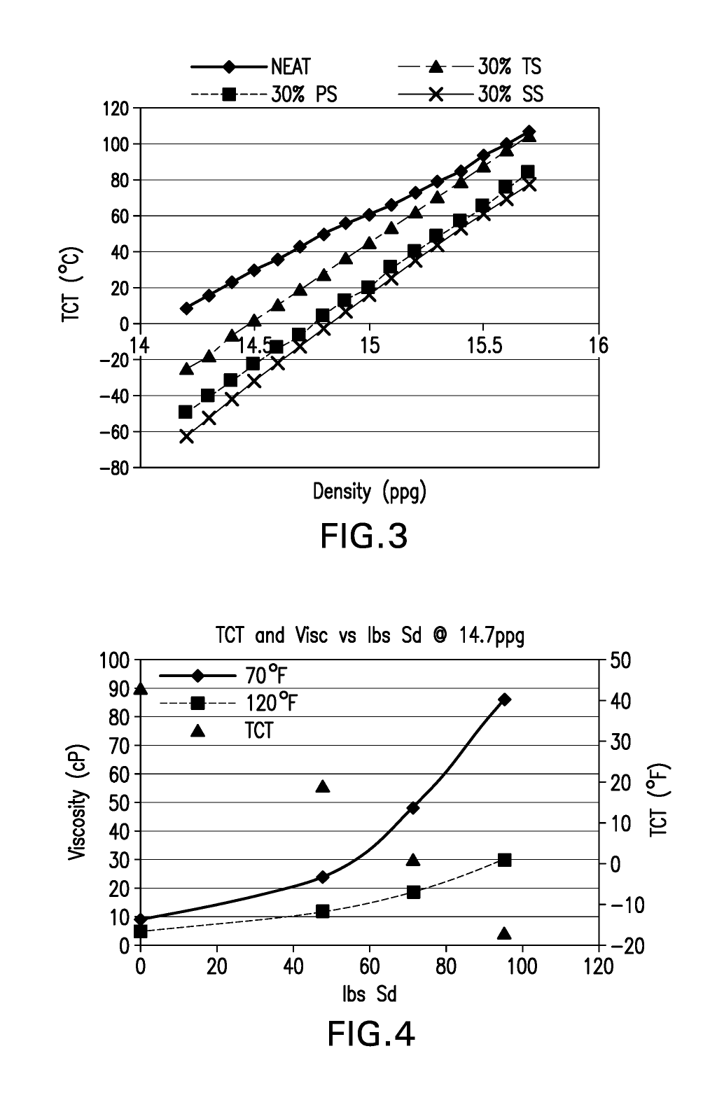

Various brines containing calcium bromide and 30 vol % of corn syrup, trehalose syrup, or sorbitol were prepared. The TCT values of the samples were tested. The results are shown in Table 1 and FIG. 3.

It was believed that the higher the density of the polyol the lower the TCT temperature. However, brines containing sorbitol have the lowest TCT values at the same loading level despite sorbitol having the middle density among the polyols tested.

TABLE 1

| | TCT (° C.) | | | |
|---|---|---|---|---|
| Density (ppg) | NEAT | 30% PS | 30% TS | 30% SS |
| 14.2 | 9 | −50 | −25 | −63 |
| 14.3 | 16 | −41 | −18 | −53 |
| 14.4 | 23 | −32 | −7 | −42 |
| 14.5 | 30 | −23 | 2 | −32 |
| 14.6 | 36 | −14 | 10 | −22 |
| 14.7 | 43 | −7 | 19 | −12 |
| 14.8 | 50 | 4 | 28 | −3 |
| 14.9 | 56 | 13 | 36 | 7 |
| 15.0 | 61 | 20 | 45 | 16 |
| 15.1 | 66 | 31 | 54 | 26 |
| 15.2 | 73 | 40 | 62 | 35 |
| 15.3 | 79 | 48 | 71 | 44 |
| 15.4 | 85 | 57 | 79 | 53 |
| 15.5 | 94 | 65 | 88 | 61 |
| 15.6 | 100 | 75 | 97 | 70 |
| 15.7 | 107 | 84 | 105 | 78 |

1. PS = Corn syrup
2. TS = Trehalose syrup
3. SS = Sorbitol syrup

### Example 4

Blends of calcium bromide brine with various types of syrups weighted to 15.2 ppg. Final tested formulations had 30 vol. % of each tested syrup. Plastic viscosity (PV) and yield point (YP) were measured. The results are shown in Table 2. It was believed that the lower the TCT value the higher the viscosity. However, sorbitol syrup readings are nearly half the corn syrup values although the sorbitol syrup-containing brines have the lower TCT value compared to core syrup-containing brines at the same loading level as shown in Table 2.

TABLE 2

| | 30% PS | | 30% SS | | 30% TS | |
|---|---|---|---|---|---|---|
| Rheometer | (TCT = 40° F.) | | (TCT = 35° F.) | | (TCT = 65° F.) | |
| Speeds (rpm) | 70° F. | 120° F. | 70° C. | 120° F. | 70° F. | 120° F. |
| 600/300 | OS/OS | 256/141 | 317/210 | 119/59 | 94/48 | 37/19 |
| 200/100 | OS/177 | 87/44 | 141/70 | 40/20 | 32/16 | 13/7 |
| 6/3 | 13/7 | 3/2 | 4/3 | 1/1 | 1/1 | 1/0 |
| PV/YP | — | 115/26 | 107/103 | 60/0 | 46/2 | 18/1 |

1. PS = Corn syrup
2. TS = Trehalose syrup
3. SS = Sorbitol syrup
4. OS = Reading is >350

### Example 5

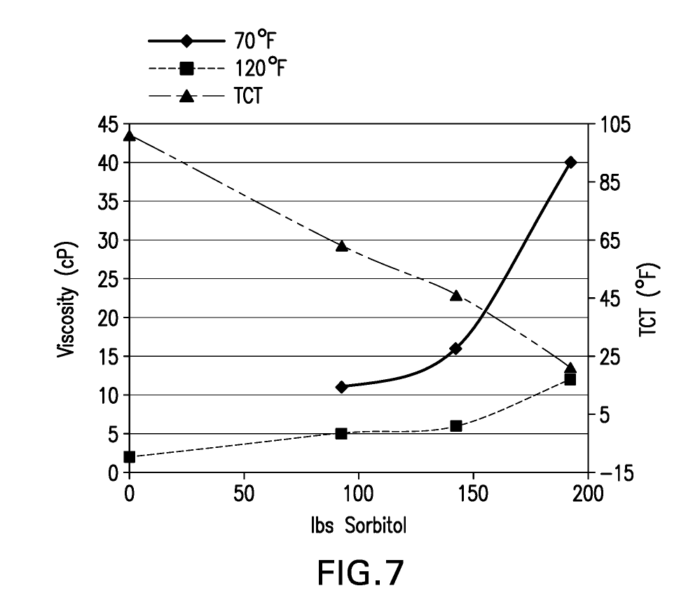

Blends of calcium bromide brine with various amounts of dry sorbitol added were tested for TCT and viscosity. The density of the blend is 14.7 ppg. The data are graphically represented in FIG. 4. The results show that increasing the amounts of sorbitol decreases TCT but increases the viscosity of the blend. FIG. 4 can be used to determine the optimum amount of sorbitol needed to prepare a 14.7 ppg brine having a target TCT value and a target viscosity. Similar figures can be obtained for brines of other densities. Switching to a monovalent brine like sodium bromide will help reduce the same viscosity vs TCT increase as shown in FIG. 7.

### Example 6

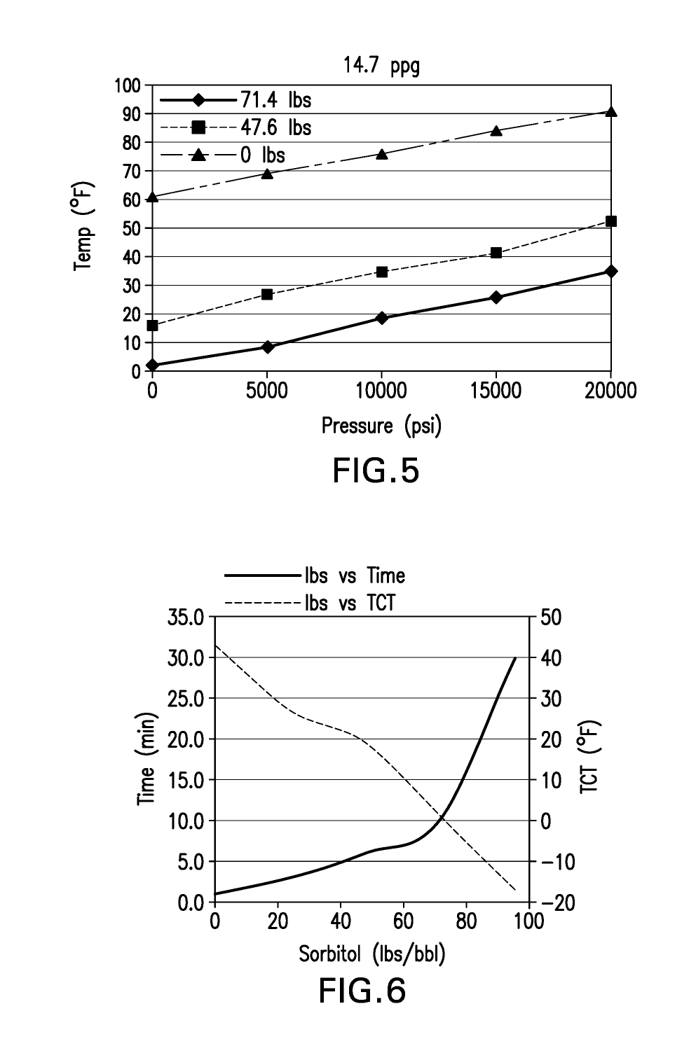

PCT (pressurized TCT) points for a 14.7 lb/gal CaBr₂ brine containing either 0, 47.6, or 71.4 lb of sorbitol per barrel of brine are shown in Table 3 and FIG. 5.

TABLE 3

| | Average PCT (° C.) | | |
|---|---|---|---|
| Pressure (psi) | 71.4 lbs sorbitol | 47.6 lbs sorbitol | 0 lbs sorbitol |
| 20,000 | 35 | 52 | 91 |
| 15,000 | 26 | 41 | 84 |
| 10,000 | 18 | 35 | 76 |
| 5,000 | 8 | 27 | 69 |
| 0 | 2 | 16 | 61 |

The data shows that at 20,000 psi for example the PCT was lowered by 56° F. using 71.4 lb of sorbitol. Typically it is desirable for a fluid with a PCT of <30° F. at 10,000 psi. At 14.7 lb/gal the brine by itself has a TCT that's 46° F. too high. By including the sorbitol, the temperature can be lowered to 35° F. or 18° F. at 10,000 psi depending on the sorbitol concentration.

Set forth are various embodiments of the disclosure.

### Embodiment 1

A method of treating a wellbore, the method comprising injecting into the wellbore a high density brine comprising: water; an inorganic salt; and a polyol having at least four hydroxyl groups per molecule, the polyol being present in an amount effective to cause the high density to have a density of about 12.5 pounds per gallon to about 22 pounds per gallon; and to suppress the true crystallization point of the brine to about −70° C. to about 70° C. at a pressure of about 0 to about 20,000 psi determined according to API 13J.

### Embodiment 2

The method of any of the preceding embodiments, wherein the polyol comprises glucose, dextrose, fructose, maltose, sorbitol, or a combination comprising at least one of the foregoing.

### Embodiment 3

The method of any of the preceding embodiments, wherein the polyol comprises sorbitol.

### Embodiment 4

The method of any of the preceding embodiments, wherein the polyol is present in an amount of about 10 wt. % to about 50 wt. %, based on the total weight of the high density brine.

### Embodiment 5

The method of any of the preceding embodiments, further comprising optimizing the amount of the polyol by preparing two or more brine samples having a target brine density from water, the inorganic salt, and the polyol having at least four hydroxyl groups per molecule, the two or more brine samples having increasing amounts of the polyol; measuring a rheological property and the true crystallization temperature of the brine samples; establishing a correlation between the amount of the polyol with the measured rheological property and true crystallization temperature; selecting an amount of the polyol based on a target value of the rheological property and target true crystallization temperature.

### Embodiment 6

The method of any of the preceding embodiments, wherein the inorganic salt comprises calcium bromide, calcium chloride, potassium chloride, potassium bromide, sodium chloride, sodium bromide, sodium formate, potassium formate, cesium formate, zinc bromide, zinc chloride, ammonium chloride, or a combination comprising at least one of the foregoing.

### Embodiment 7

The method of any of the preceding embodiments, wherein the inorganic salt is present in an amount of about 2 to about 75 wt. % based on the total weight of the high density brine.

### Embodiment 8

The method of any of the preceding embodiments, wherein the high density brine has a density of about 15 ppg to about 20 ppg.

### Embodiment 9

The method of any of the preceding embodiments, wherein the high density brine is a single salt brine comprising calcium bromide in an amount of about 50 to about 55 wt. % and sorbitol present in an amount of about 20 wt. % to about 40 wt. %, each based on a total weight of the high density brine, and the high density brine has a density of about 14.4 ppg to about 15.7 ppg and a TCT of about −70° F. to about 76° F. determined according to API 13J.

### Embodiment 10

The method of any of the preceding embodiments, wherein the high density brine is a single salt brine comprising calcium chloride in an amount of about 33 wt. % to about 40 wt. % and sorbitol present in an amount of about 20 wt. % to about 40 wt. %, each based on a total weight of the high density brine, and the high density brine has a density of about 11.0 ppg to about 12.4 ppg and a TCT of about −40° F. to about 70° F. determined according to API 13J.

### Embodiment 11

The method of any of the preceding embodiments, wherein the high density brine is a completion brine, a perforating brine, a packer brine, a drill-in brine, and an oil-based mud internal phase.

### Embodiment 12

The method of any of the preceding embodiments, further comprising circulating the high density brine in the wellbore.

### Embodiment 13

The method of any of the preceding embodiments, wherein the high density brine is injected into the wellbore during a wellbore operation. The wellbore operation is a completion operation, a drilling operation, a workover operation, an abandonment operation, or a combination comprising at least one of the foregoing.

### Embodiment 14

The method of any of the preceding embodiments, further comprising combining the polyol in a solid form with the inorganic salt and water to form the high density brine.

### Embodiment 15

The method of any of the preceding embodiments, further comprising combining the polyol in a solution to with the inorganic brine and water to form the high density brine.

### Embodiment 17

The method of any of the preceding embodiments, wherein the high density brine has a viscosity of about 6 cp to about 300 cP at 21° C. determined according to API 13J.

### Embodiment 18

The method of any of the preceding embodiments, wherein the high density brine is free of zinc bromide.

### Embodiment 19

A method of making a high density brine having a balanced density, true crystallization temperature, and rheology, the method comprising: preparing two or more brine samples having a target brine density from water, an inorganic salt, and a polyol having at least four hydroxyl groups per molecule, the two or more brine samples having increasing amounts of the polyol; measuring a rheological property and the true crystallization temperature of the brine samples; establishing a correlation between the amount of the polyol with the measured rheological property and true crystallization temperature; selecting an amount of the polyol based on a target value of the rheological property and target true crystallization temperature; and preparing the high density brine having a balanced density, true crystallization temperature, and rheological property.

### Embodiment 20

The method of any of the preceding embodiments, wherein the rheology property is viscosity.

### Embodiment 21

The method of any of the preceding embodiments, wherein the polyol comprises glucose, dextrose, fructose, maltose, sorbitol, or a combination comprising at least one of the foregoing.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

What is claimed is:

1. A method of treating a wellbore, the method comprising injecting into the wellbore a high density brine comprising:
water;
an inorganic salt; and
a polyol having at least four hydroxyl groups per molecule, the polyol being present in an amount effective to cause the high density to have a density of about 12.5 pounds per gallon to about 22 pounds per gallon; and to suppress the true crystallization point of the brine to about −70° C. to about 70° C. at a pressure of about 0 to about 20,000 psi determined according to API 13J.

2. The method of claim 1, wherein the polyol comprises glucose, dextrose, fructose, maltose, sorbitol, or a combination comprising at least one of the foregoing.

3. The method of claim 1, wherein the polyol comprises sorbitol.

4. The method of claim 1, wherein the polyol is present in an amount of about 10 wt. % to about 50 wt. %, based on the total weight of the high density brine.

5. The method of claim 1, further comprising optimizing the amount of the polyol by preparing two or more brine samples having a target brine density from water, the inorganic salt, and the polyol having at least four hydroxyl groups per molecule, the two or more brine samples having increasing amounts of the polyol; measuring a rheological property and the true crystallization temperature at a predetermined pressure for each of the brine samples; establishing a correlation between the amount of the polyol with the measured rheological property and true crystallization temperature; selecting an amount of the polyol based on a target value of the rheological property and target true crystallization temperature.

6. The method of claim 1, wherein the inorganic salt comprises calcium bromide, calcium chloride, potassium chloride, potassium bromide, sodium chloride, sodium bromide, sodium formate, potassium formate, cesium formate, zinc bromide, zinc chloride, ammonium chloride, or a combination comprising at least one of the foregoing.

7. The method of claim 1, wherein the inorganic salt is present in an amount of about 2 to about 75 wt. % based on the total weight of the high density brine.

8. The method of claim 1, wherein the high density brine has a density of about 15 ppg to about 20 ppg.

9. The method of claim 1, wherein the high density brine is a single salt brine comprising calcium bromide in an amount of about 50 to about 55 wt. % and sorbitol present in an amount of about 20 wt. % to about 40 wt. %, each based on a total weight of the high density brine, and the high density brine has a density of about 14.4 ppg to about 15.7 ppg and a TCT of about −70° F. to about 76° F. determined according to API 13J.

10. The method of claim 1, wherein the high density brine is a single salt brine comprising calcium chloride in an amount of about 33 wt. % to about 40 wt. % and sorbitol present in an amount of about 20 wt. % to about 40 wt. %, each based on a total weight of the high density brine, and the high density brine has a density of about 11.0 ppg to about 12.4 ppg and a TCT of about −40° F. to about 70° F. determined according to API 13J.

11. The method of claim 1, wherein the high density brine is a completion brine, a perforating brine, a packer brine, a drill-in brine, and an oil-based mud internal phase.

12. The method of claim 1, further comprising circulating the high density brine in the wellbore.

13. The method of claim 1, wherein the high density brine is injected into the wellbore during a wellbore operation.

14. The method of claim 13, wherein the wellbore operation is a completion operation, a drilling operation, a workover operation, an abandonment operation, or a combination comprising at least one of the foregoing.

15. The method of claim 1, further comprising combining the polyol in a solid form with the inorganic salt and water to form the high density brine.

16. The method of claim 1, further comprising combining the polyol in a solution to with the inorganic brine and water to form the high density brine.

17. The method of claim 1, wherein the high density brine has a viscosity of about 6 cp to about 300 cP at 21° C. determined according to API 13J.

18. The method of claim 1, wherein the high density brine is free of zinc bromide.

19. A method of making a high density brine having a balanced density, true crystallization temperature, and rheology, the method comprising:
preparing two or more brine samples having a target brine density from water, an inorganic salt, and a polyol having at least four hydroxyl groups per molecule, the two or more brine samples having increasing amounts of the polyol;
measuring a rheological property and the true crystallization temperature at a predetermined pressure for each of the brine samples;
establishing a correlation between the amount of the polyol with the measured rheological property and true crystallization temperature;
selecting an amount of the polyol based on a target value of the rheological property and target true crystallization temperature; and
preparing the high density brine having a balanced density, true crystallization temperature, and rheological property with water, the inorganic salt, and the selected amount of the polyol.

20. The method of claim 19, wherein the rheology property is viscosity.

21. The method of claim 19, wherein the polyol comprises glucose, dextrose, fructose, maltose, sorbitol, or a combination comprising at least one of the foregoing.
